(19) United States
(12) Patent Application Publication
(10) Pub. No.: US 2014/0071076 A1
(43) Pub. Date: Mar. 13, 2014

(54) METHOD AND SYSTEM FOR GESTURE RECOGNITION

(71) Applicant: Samsung Electronics Co., Ltd., Gyeonggi-do (KR)

(72) Inventors: Debi Prosad DOGRA, West Bengal (IN); Saurabh TYAGI, Uttar Pradesh (IN)

(73) Assignee: Samsung Electronics Co., Ltd., Gyeonggi-do (KR)

(21) Appl. No.: 14/024,215

(22) Filed: Sep. 11, 2013

(30) Foreign Application Priority Data
Sep. 13, 2012 (IN) 2866/DEL/2012

(51) Int. Cl. G06F 3/01

(52) U.S. Cl. CPC G06F 3/017
USPC 345/173

(57) ABSTRACT

A gesture recognition system receives input data from a sensor comprising data representing at least one gesture motion. The system divides a space associated with gesture detection by the sensor into a plurality of blocks and assigns the plurality of blocks to corresponding states. A gesture specific sequence of states is generated in response to the received input data and a gesture is recognized in response to the generated gesture specific sequence.

### CLAIM OF PRIORITY

This application claims the benefit of priority under 35 U.S.C. §119(a) from an Indian Patent Application filed in the Indian Patent Office on Sep. 13, 2012 and assigned Serial No. 2866/CHE/2012, the entire disclosure of each of which is hereby incorporated by reference.

### BACKGROUND

1. Field of the Invention

The present invention relates to gesture recognition and more particularly to a generalized framework for the gesture recognition using Deterministic Finite Automata (DFA).

2. Description of the Related Art

Gesture recognition techniques are widely used for interpreting human gestures. Gestures can be made through face, hand, fingers, or another body motion. The use of the gesture recognition methods can enable a system to recognize or identify the normal or specific gestures and use them to convey information or facilitate device control.

Known gesture recognition systems allows an electronic device to capture input from a user using an input interface. The gesture recognition methods used by the existing systems use a predefined set of rules to recognize the gestures, which are often specific to the type of the input interface. Further, the same set of rules is not applicable for recognizing other type of gestures. Thus, most of the known methods are application specific and fail to recognize complex gestures including movements of more than one object.

In the light of above discussion, a system according to invention principles provides gesture recognition recognizing complex gestures independently of an input interface used by a device and addressing the identified deficiencies and related problems.

### SUMMARY

A system according to invention principles provides a method for gesture recognition using, in one embodiment Deterministic Finite Automata (DFA), for example. A method for gesture recognition, receives input data from a sensor comprising data representing at least one gesture motion and divides a space associated with gesture detection by the sensor into a plurality of blocks. The method assigns the plurality of blocks to corresponding states, generates a gesture specific sequence of states in response to the received input data and recognizes a gesture in response to the generated gesture specific sequence.

In a feature of the invention, the method uses Deterministic Finite Automata (DFA) in generating a gesture specific DFA and the at least one gesture motion is provided by a user based on at least one stroke, wherein the at least one stroke comprises at least one of valid stroke and invalid stroke. The at least one stroke further comprises a pointer indicating at least one orientation of the gesture motion. The method constructs the gesture specific sequence of states in response to at least one of alphabet, state transition rule, initial state, set of final states, and set of finite states, and the alphabet comprises the at least one of valid stroke and invalid stroke.

The method recognizes a gesture in response to the generated gesture specific sequence, by receiving the gesture input from the user, generating at least one string of symbols of the gesture in response to the alphabet, determining whether the at least one string of symbols matches the generated gesture specific sequence and recognizing the gesture in response to determining that the at least one string of symbols matches the generated gesture specific sequence. The space associated with gesture detection by the sensor comprises at least one of a real gesture space of the sensor and a virtual gesture space and a two dimensional space or a three dimensional space.

In a further feature of the invention, the method further comprises recognizing a multi-stroke gesture by using a sequential representation of the at least one stroke that is spanned over the at least one block. The method further comprises transferring at least one object between a first device and a second device in response to the recognized gesture. The object is transferred using at least one of send command and receive command executed by the at least one of first device and second device in response to the recognized gesture.

In another feature of the invention, a system for gesture recognition uses an interface module configured to receive input data from a sensor comprising data representing at least one gesture motion. A module is configured to: divide a space associated with gesture detection by the sensor into a plurality of blocks, assign the plurality of blocks to corresponding states, and generate a gesture specific sequence of states in response to the received input data; and a gesture recognition module configured to recognize a gesture in response to the generated gesture specific sequence.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates an apparatus with multiple modules, according to invention principles;

FIG. 2 illustrates a virtual gesture space divided into subspaces, according to invention principles;

FIG. 3 illustrates construction of an alphabet using simplified single stroke-gesture recognition, according to invention principles;

FIG. 4 illustrates a flow diagram for constructing a Deterministic Finite Automata (DFA) for gesture recognition, according to invention principles;

FIG. 5 illustrates a flow diagram for validating an input gesture using the constructed DFA, according to invention principles;

FIG. 6 illustrates an exemplary state transition diagram representing a DFA for the single-stroke gestures, according to invention principles;

FIG. 7 illustrates an exemplary state transition diagram of a DFA designed for describing a complex gesture, according to invention principles;

FIG. 8 illustrates a flow diagram of the DFA as described in the FIG. 7, according to invention principles;

FIG. 9 illustrates possible scenarios in a multi-stroke gesture recognition framework, according to invention principles;

FIG. 10 illustrates a generalized framework of the gesture recognition used in an object transfer application, according to invention principles;

FIG. 11 illustrates a state transition diagram corresponding to the gestures performed for the object transfer between devices depicted in the FIG. 10, according to invention principles;

FIG. 12 illustrates a generalized framework of gesture recognition used in Augmented Reality (AR) application, according to invention principles; and

FIG. 13 illustrates a computing environment implementing the application, according to invention principles.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system to provide a generalized framework for gesture recognition using Deterministic Finite Automata (DFA). A virtual space is advantageously divided into sub-spaces and assigned to independent states of a DFA module. A single or multi strokes representation is determined based on orientation and movement of a pointer involved in a gesture. The present invention provides the DFA based methodology to advantageously identify the single or multi-stroke based gestures. The method provides a complete set of possible strokes to address possible movement of pointer involved in the gesture. Further, the DFA module is advantageously used to construct a gesture specific DFA to represent a complex gesture performed by a user. The constructed DFA represents a predefined gesture, which is used by a gesture recognition module to recognize an input gesture captured by a device.

Throughout the description, the terms subspace and block are used interchangeably.

Throughout the description, the terms complex gesture and multi stroke gestures are used interchangeably.

Throughout the description, the terms invalid stroke and unacceptable stroke are used interchangeably.

The generalized framework disclosed by the method enhances the input methods for recognizing the gestures performed by the user. The generalized framework for the gesture recognition can be used for various applications, for example, authentication, object movement, augmented reality, gaming, user interface designing, or another application. Similarly, the generalized framework for the gesture recognition can be used in various electronic systems, for example, mobile phones, Personal Digital Assistant (PDA), augmented reality systems, gaming systems, or another system.

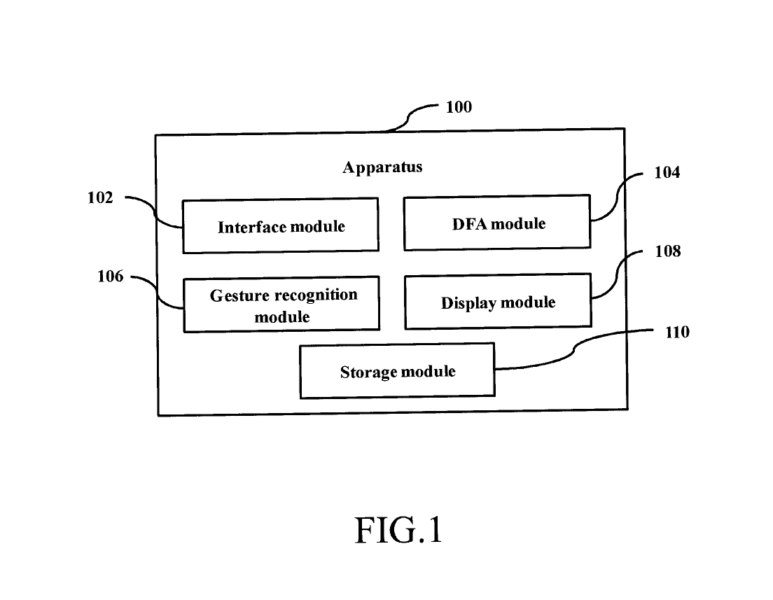

Referring now to the drawings, and more particularly to FIGS. 1 through 13, where similar reference characters denote corresponding features consistently throughout the figures, there are shown preferred embodiments.

FIG. 1 illustrates apparatus 100 including an interface module 102, a DFA module 104, a gesture recognition module 106, a display module 108, and a storage module 110. The interface module 102 is configured to provide a user interface to capture a gesture performed by a user over a real gesture space. In an example, the input interface module 102 described herein can be a touch screen, touch pad, camera, joystick, or another input interface module. In an example the gesture described herein includes, but is not limited to, a hand movement in front of a camera, a video tracking result, a pattern on a touch screen, a touch pad using a stylus (or finger), or another motion or movement made by the user.

The DFA module 104 is configured to, divide the gesture space into multiple non-overlapping blocks, include different states, which are assigned to the multiple non-overlapping blocks of the gesture space and to construct a gesture specific DFA. The gesture recognition module 106 is configured to provide the generalized framework for gesture recognition using the DFA module 104. The gesture recognition framework is provided independent of the interface module 102 used by the apparatus 100. The display module 108 displays a gesture performed by a user on the display screen, along with other display functions of the apparatus 100. The non-transitory storage module 110 is configured to provide a storage space for storing the constructed DFA and a captured user gesture, along with the standard memory functions. The storage module 110 described herein may be configured to include an internal memory or use an external memory.

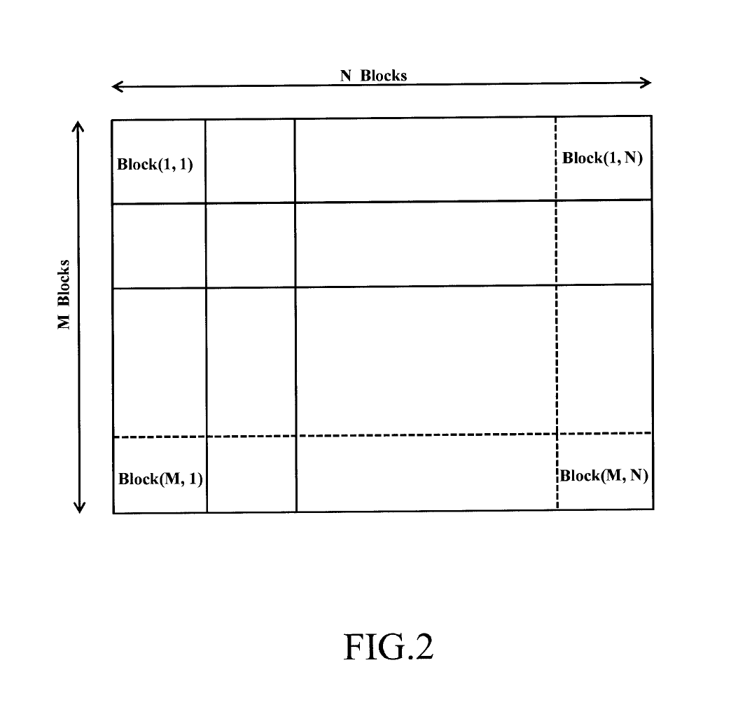

FIG. 2 illustrates a virtual gesture space divided into subspaces and mapped to the real gesture space. The real gesture space described herein includes a touch panel, view of the camera, sensor, or another input sensor. The entire rectangular virtual space is divided into non-overlapping blocks having M rows and N columns such that the device can create total of M×N subspaces. Further, these subspaces are assigned to independent states of the finite automaton.

The gesture performed by the user over the real gesture space is sensed and mapped to the virtual gesture space. The representation of a gesture is simplified as movement of a pointer from a source (start) subspace to a destination (final) subspace through the intermediate subspaces. Thus, the apparatus is enabled for tracking multi-stroke gesture performed by the user. The movement of the pointer from a subspace to an adjacent subspace represents a single-stroke gesture. Thus, the multi-stroke gesture performed by the user during the movement of the pointer from the source to the destination is represented by a string of symbols. This string includes sequence of all the single-stroke gesture, which represents the multi-stroke gesture. In an example, the number of subspaces created can vary based on the user requirement. A higher number of subspaces can enable more accurate gesture recognition. In an embodiment the gesture space can include any shape which is divided into non overlapping subspaces.

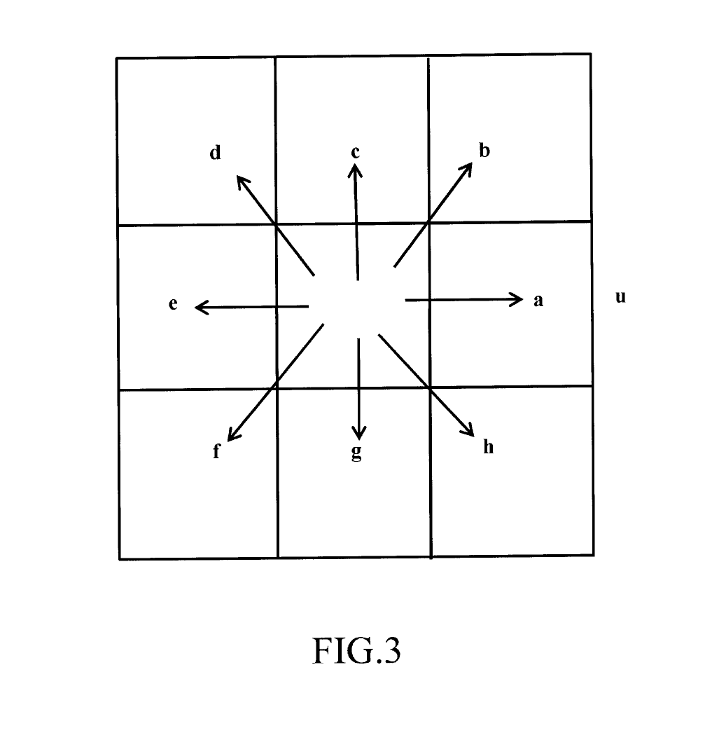

FIG. 3 illustrates construction of an alphabet using simplified single-stroke gesture recognition using a complete set of possible single strokes in a gesture to address a possible movement of the pointer. The complete set of possible single strokes described is for example, a, b, c, d, e, f, g, and h as shown in the FIG. 3. The possible single strokes in a gesture are differentiated based on the orientation and movement of the pointer. Further, FIG. 3 represents an unacceptable stroke (also referred as invalid movement of pointer interchangeably) as ‘u’. In an example, the sequence of the single-stroke gestures represent a multi-stroke gesture. Further, a gesture specific DFA may be constructed to represent a multi-stroke gesture.

In an embodiment, the DFA (denoted by M) defines a five tuple, given in an equation below:

M={Σ, Q, δ, S, Q_{F}}

Where, Σ represents the alphabets (a set of finite symbols or number of possible inputs), Q is a set of finite states, δ is a set of production rules (or a rule transition table), S is a start state, and Q_{F} is a set of final states (or accept states).

A method defines the input alphabet Σ having a vector representation as depicted in FIG. 3. The pointer of an input gesture enters into one of the eight possible sub-spaces and are represented by symbols such that Σ={a, b, c, d, e, f, g, h, u}, where a, b, c, d, e, f, g, and h represent the set of possible (valid) single strokes and ‘u’ represents another stroke such as an invalid or unacceptable stroke. The horizontal stroke in the right direction is ‘a’, the upward diagonal stroke in right direction is ‘b’, vertically upward stroke is ‘c’, the upward diagonal stroke in left direction is ‘d’, the horizontal stroke in left direction is ‘e’, the downward diagonal stroke in left direction is ‘f’, the vertically downward stroke is ‘g’, the downward diagonal stroke in right direction is ‘h’, and a stroke other than these defined strokes is an invalid stroke represented by ‘u’. In an embodiment, the symbols used to represent the strokes, can have other user defined characters.

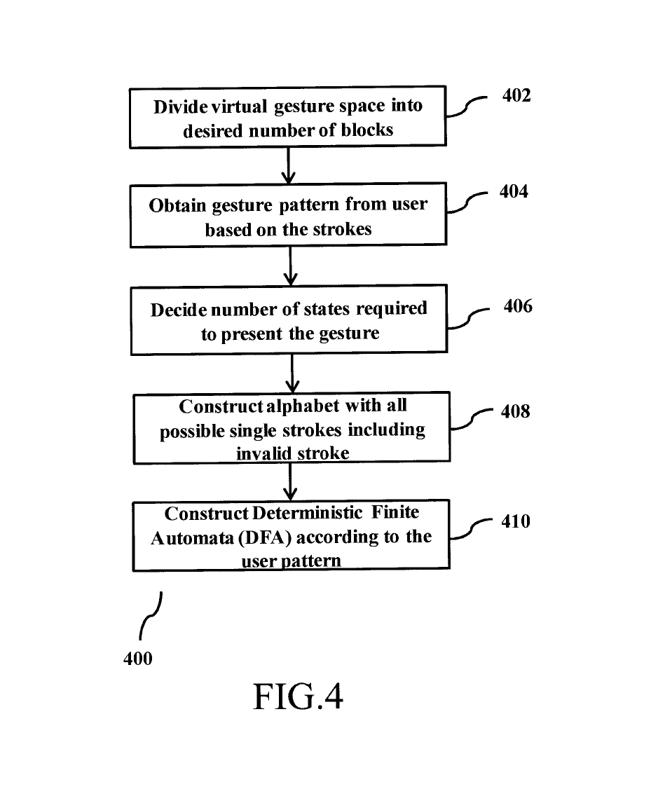

FIG. 4 illustrates a flow diagram 400 for constructing DFA for gesture recognition where, at step 402, the gesture space is divided into a desired number of blocks. At step 404, the possible gesture map based on the composite (complex) strokes is obtained from the input gesture performed by the user. In response to receiving the gesture, at step 406, the number of states required to present the gesture map are finalized. At step 408, the alphabet Σ required for defining the DFA (M) is constructed. The alphabet Σ includes possible single strokes including the invalid stroke. At step 410, a DFA (M) specific to a user gesture is constructed. The DFA (M) is constructed by using the state transition rules, initial (start) state, and a set of final states based on the user gesture.

The method enables the apparatus to construct multiple DFAs corresponding to the multiple user gestures. Each constructed DFA represents a different gesture and execute a corresponding function.

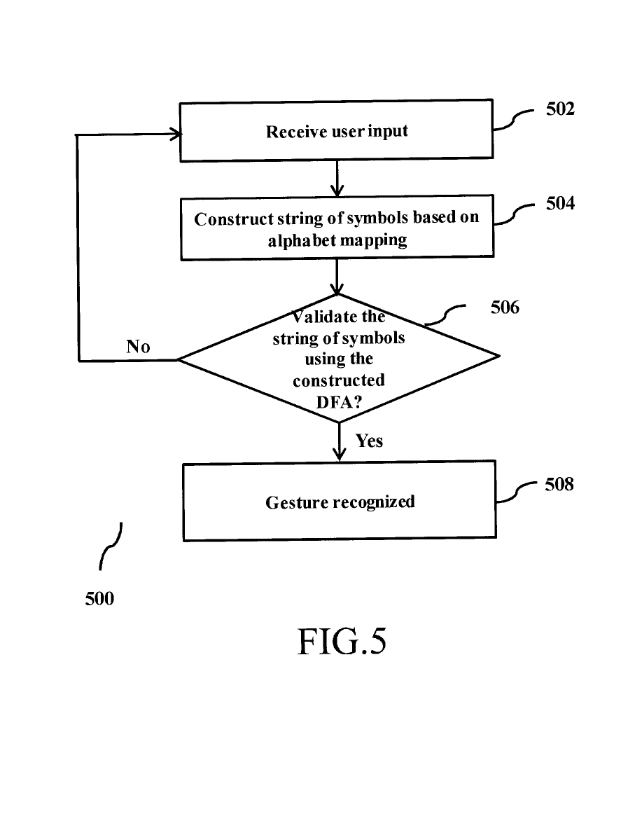

FIG. 5 illustrates a flow diagram 500 for validating an input gesture using the constructed DFA where, at step 502, the apparatus 100 accepts the input gesture performed by the user. At step 504, a string comprising a combination of symbols of alphabet Σ is constructed based on the mapping of the input gesture with the symbols of the alphabet Σ. These symbols of the string represent the multi-stroke gesture as a sequence of single-stroke gestures. The constructed string of symbols represents the input gesture performed. At step 506, the string of symbols is compared with the constructed DFA of FIG. 4. The constructed DFA represents the DFA of a predefined or registered gesture. If the input string is accepted by the DFA, at step 508, the gesture is recognized and the apparatus 100 executes a predefined function for the input gesture. At step 506, upon determining a mismatch, the apparatus starts another process iteration at step 502.

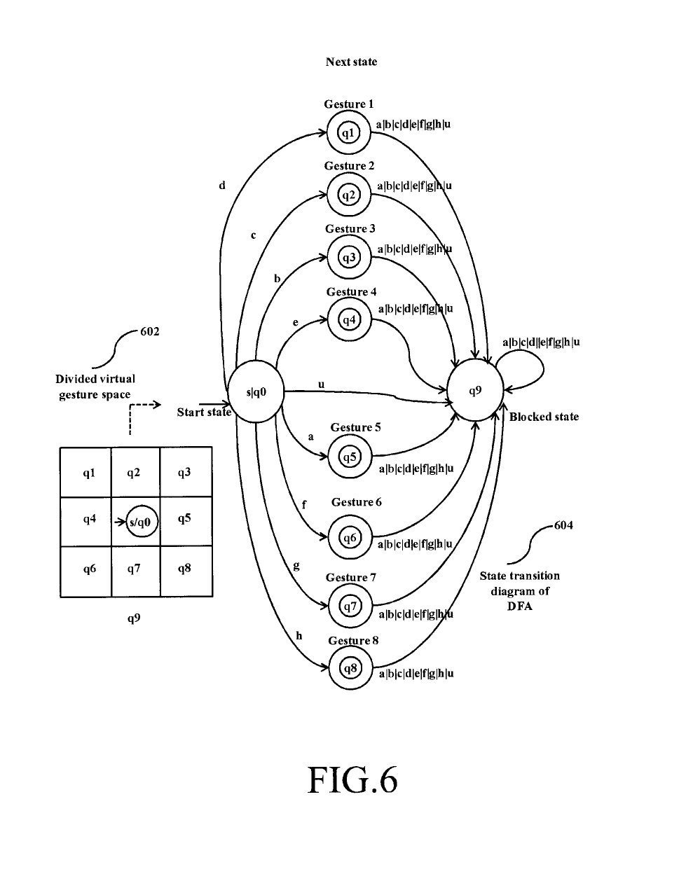

FIG. 6 illustrates an exemplary state transition diagram representing a DFA for the single-stroke gestures depicting a simplified representation of a divided virtual gesture space 602 with nine non-overlapping sub-spaces assigned to each corresponding individual state of state transition diagram 604 of the DFA. The blocks of the divided virtual space 602 are assigned to the states q0, q1, q2, q3, q4, q5, q6, q7, and q8. The state q9 is a blocked/invalid state assigned to an invalid stroke. Possible gestures begin from the central block assigned to the state q0. The central block is alternatively denoted by ‘S’ representing the start state of a DFA. Starting from the block q0 there may be eight possible gestures (single stroke movement from start block S/q0 to another adjacent block). The different single stroke gestures include movement of the pointer from states q0 to q1, q0 to q2, q0 to q3, q0 to q4, q0 to q5, q0 to q6, q0 to q7, and q0 to q8. Another movement of the pointer forces the state transition to enter into the blocked state q9.

The state transition diagram 604 of the DFA represents eight acceptable events (single strokes) within the divided virtual space 602. The state transition diagram of DFA 604 defines a DFA (M) as

M={Σ, Q, δ, q₀, Q_{F}}.

Where, Σ={a, b, c, d, e, f, g, h, u}. The characters a, b, c, d, e, f, g, and h represent the valid strokes. The character ‘u’ represents an unacceptable stroke, which leads the state transition to enter into the blocked state.

The set of possible states is given by Q={q0, q1, q2, q3, q4, q5, q6, q7, q8, q9}. The state q0 represents the start state (S). The set of acceptable states is given by Q_{F}={q1, q2, q3, q4, q5, q6, q7, q8} and the production rules of the DFA are defined as δ: {Σ×Q}−>Q.

The production rules for state transition diagram of the DFA 604 are as follows:
δ(S, a)=q5 (rule states that the pointer movement from the S in direction of vector ‘a’ allows the state transition to enter into the state q5, which is an acceptable state),
δ(S, b)=q3 (rule states that the pointer movement from the S in direction of vector ‘b’ allows the state transition to enter into the state q3, which is an acceptable state),
δ(S, c)=q2 (rule states that the pointer movement from the S in direction of vector ‘c’ allows the state transition to enter into the state q2, which is an acceptable state),
δ(S, d)=q1 (rule states that the pointer movement from the S in direction of vector ‘d’ allows the state transition to enter into the state q1, which is an acceptable state),
δ(S, e)=q4 (rule states that the pointer movement from the S in direction of vector ‘e’ allows the state transition to enter into the state q4, which is an acceptable state),
δ(S, f)=q6 (rule states that the pointer movement from the S in direction of vector ‘f’ allows the state transition to enter into the state q6, which is an acceptable state)
δ(S, g)=q7 (rule states that the pointer movement from the S in direction of vector ‘g’ allow the state transition to enter into the state q7, which is an acceptable state),
δ(S, h)=q8 (rule states the pointer movement from the S in direction of vector ‘h’ allows the state transition to enter into the state q8, which is an acceptable state), and
δ(S, u)=q9 (rule states that the pointer movement from the S in another direction termed vector ‘u’ allows the state transition to enter into the state q9, which is an unacceptable state).

The rules stated below indicate a stroke starting from a state other than the q0 (comprising the states q1, q2, q3, q4, q5, q6, q7, and q8) in direction of a vector such as a, b, c, d, e, g, f, h, or u allows the state transition to enter into the state q9 representing the unacceptable state.

δ(q₁,a|b|c|d|e|f|g|h|u)=q₉

δ(q₂,a|b|c|d|e|f|g|h|u)=q₉

δ(q₃,a|b|c|d|e|f|g|h|u)=q₉

δ(q₄,a|b|c|d|e|f|g|h|u)=q₉

δ(q₅,a|b|c|d|e|f|g|h|u)=q₉

δ(q₆,a|b|c|d|e|f|g|h|u)=q₉

δ(q₇,a|b|c|d|e|f|g|h|u)=q₉

δ(q₈,a|b|c|d|e|f|g|h|u)=q₉

δ(q₉,a|b|c|d|e|f|g|h|u)=q₉

Once the state transition enters into a blocked state, then a further movement (stroke) is considered to be an invalid stroke and the state transition is held in the blocked state q9.

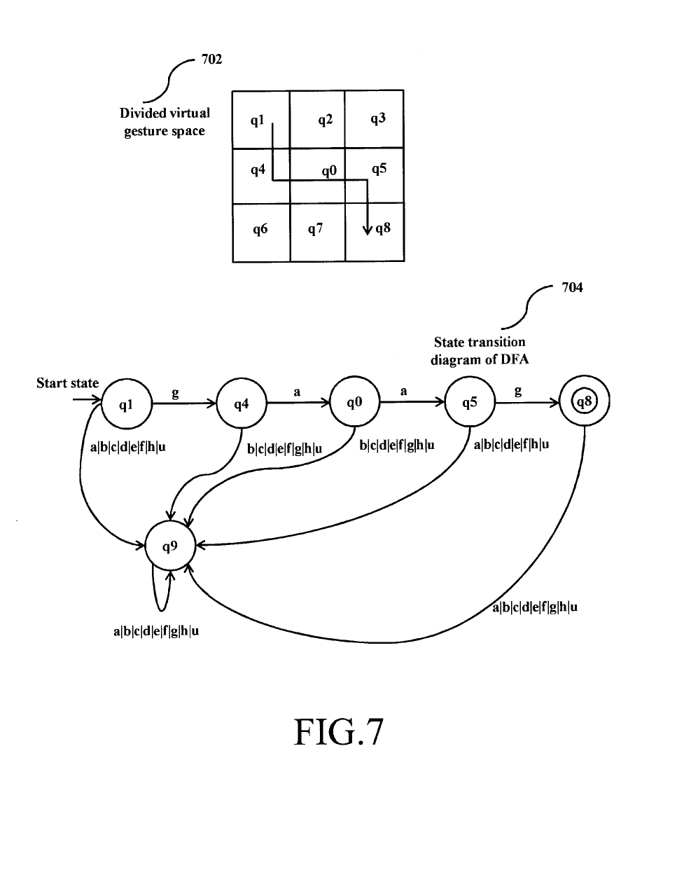

FIG. 7 illustrates an exemplary state transition diagram 704 of the DFA describing a complex gesture where a virtual gesture space 702 is divided into nine blocks, on which a complex gesture is mapped. A complex gesture or a multi stroke gesture comprises a series of strokes q₁->q₄->q₀->q₅->q₈, for example. These single strokes represent the movement of the gesture pointer from a subspace represented by the state q1 to a sub-space represented by the state q8 through the intermediate subspaces q4, q0, and q5. The complex gesture starts at the q1, moves in direction of the stroke g and enters into the state q4, moves in the direction of the stroke a and enters into the state q0, further moves in the direction of the stroke a and enters into the state q5, thereafter moves in the direction of the stroke g and enters into the final acceptable state q8.

The DFA (M₁) for the complex gesture is represented by M₁={Σ, Q, δ, S, Q_{F}}, where Σ is a set of alphabets as described and Σ={a, b, c, d, e, f, g, h, u}, Q={q₁, q₄, q₀, q₅, q₈, q₉} is the set of states, S=q1 is the start state, Q_{F}={q8} is the set of final states (or acceptable state), and δ is the set of production rules as defined below:

δ(q1,g)=q4

δ(q1,a|b|c|d|e|f|h|u)=q9

δ(q4,a)=q0

δ(q4,a|b|c|d|e|f|g|h|u)=q9

δ(q0,a)=q5

δ(q0,b|c|d|e|f|g|h|u)=q9

δ(q5,g)=q8

δ(q5,a|b|c|d|e|f|h|u)=q9

δ(q8, a|b|c|d|e|f|g|h|u)=q9

The state transition enters into the unacceptable state q9 in accordance to the rules defined in the rule table. Once the state transition enters into a blocked state a further stroke in the direction of a vector is an invalid stroke and the state transition is held in the blocked state q9.

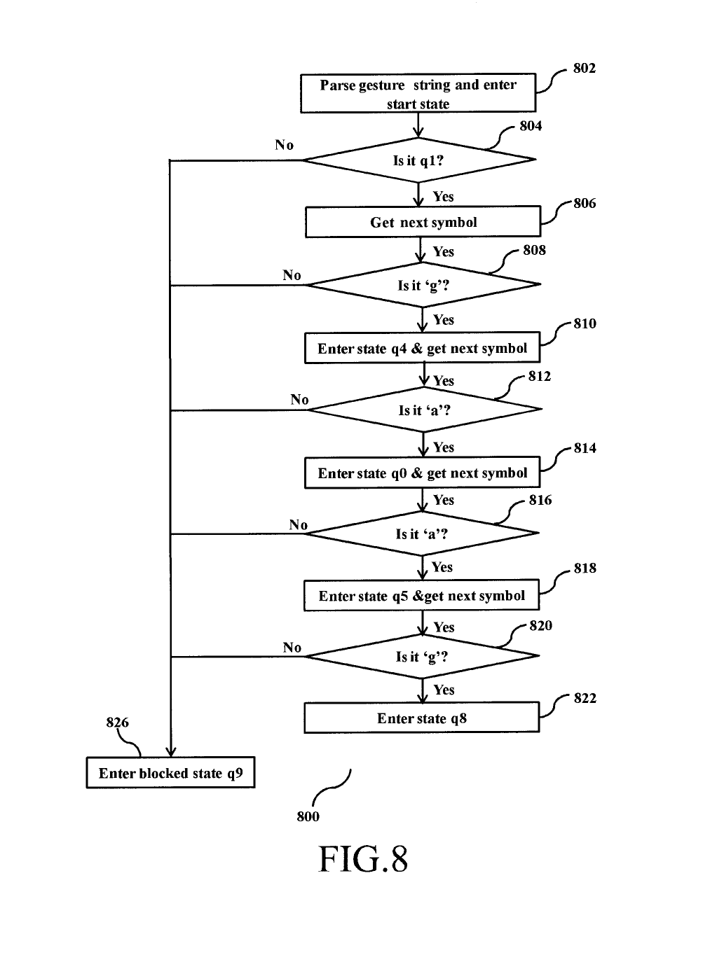

FIG. 8 illustrates a flow diagram 800 of the DFA as described in FIG. 7 and representing the steps performed during the verification (recognition) of the complex gesture q₁->q₄->q₀->q₅->q₈. The user performs a gesture, which is captured by the interface module 102. The gesture is mapped to the divided virtual gesture space. The string of symbols using the alphabet Σ is generated by mapping the sequence of single strokes in a gesture to the vectors a, b, c, d, e, f, g, h, and u of the alphabet Σ. At step 802, the string of symbols based on the alphabet mapping is parsed and the state transition enters into the starting state in accordance to the received string of symbols. In an example, the string of symbols for a gesture to be recognized as a valid gesture is g, a, a, g as described in the state transition diagram of the FIG. 7. At step 804, the start state is verified. At step 806, in response to verifying that the start state is q1, the first symbol is accepted else the state transition enters into a blocked state q9, as shown at step 826. At step 808, the accepted first symbol of the string is verified with the alphabet symbol ‘g’. At step 810 in response to verifying that the first symbol is ‘g’, the state transition enters into the state ‘q4 and accepts the second symbol of the string. At step 826, in response to verifying that the first symbol is not ‘g’, the state transition enters into the blocked state q9.

At step 812, the second symbol is verified. If the second symbol is ‘a’, at step 814, the state transition enters into the state q0. At step 826, in response to verifying that the second symbol is not ‘a’, the state transition enters into the blocked state q9. At step 816, the third symbol is verified. If the third symbol is ‘a’, at step 818, the execution enters into the state q5. At step 826, in response to verifying that the third symbol is not ‘a’, the state transition enters into the blocked state q9. At step 820, the fourth symbol is verified. At step 822, in response to verifying that the fourth symbol is ‘g’, the state transition enters into the state q8. At step 826, in response to verifying that the fourth symbol is not ‘g’, the state transition enters into a blocked state q9. Upon a successful verification of all the symbols, the execution recognizes the input gesture. The various steps described with respect to FIG. 8 may be performed in the order presented, in a different order or simultaneously. Further, in some embodiments, some steps listed in the FIG. 8 may be omitted or added without departing from the scope of the invention.

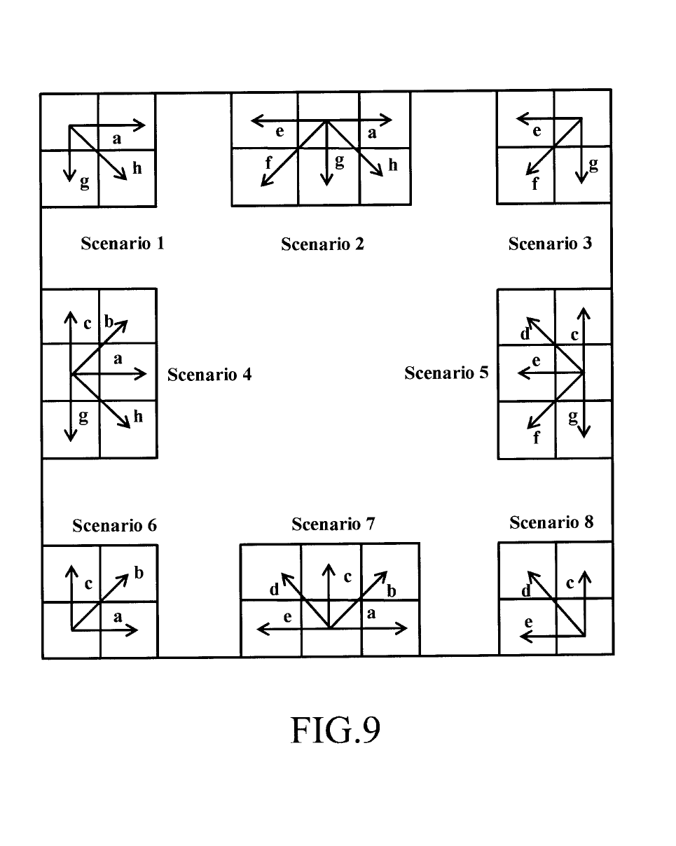

FIG. 9 illustrates possible scenarios in a multi-stroke gesture recognition framework and depicts a virtual space divided into multiple non-overlapping blocks along with the possible scenarios of the multi-stroke gestures. The eight scenarios depicted in the FIG. 9, along with scenario mentioned in the FIG. 3, represents boundary conditions of any multi-stroke based gesture.

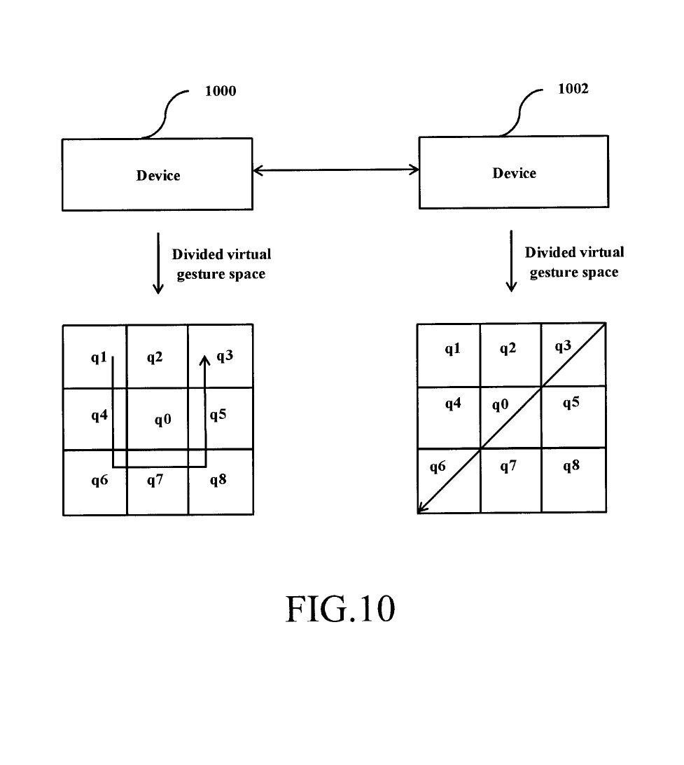

FIG. 10 illustrates a generalized framework of the gesture recognition used in an object transfer application and depicts devices 1000 and 1002 with their virtual spaces divided into nine non overlapping blocks and corresponding nine states q0 to q8 along with the blocked state q9. The devices 1000 and 1002 can communicate with each other through an available communication channel. The virtual space of the device 1000 depicts a multi stroke gesture with states q1->q4->q6->q7->q8->q5->q3. The virtual space of the device 1002 depicts a multi stroke gesture with states q3->q0->q6. For the devices 1000 and 1002 DFA corresponding to the respective gestures are constructed. A user sends an object from the device 1000 by performing the gesture q1->q4->q6->q7->q8->q5->q3. A valid gesture performed by the user executes a send command and the selected object is sent through the communication channel. A user performs a valid gesture q3->q0->q6 on the device 1002, which executes a receive command, and receives the object sent by the device 1000 over the communication channel.

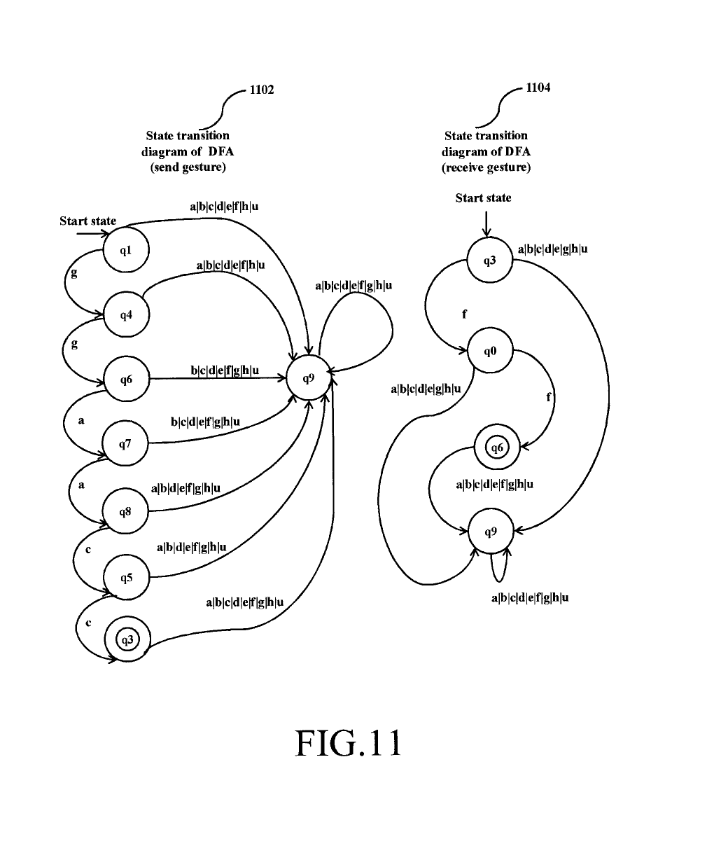

FIG. 11 illustrates a state transition diagram corresponding to the gestures performed for the object transfer between devices depicted in FIG. 10. A state transition diagram 1102 of a DFA corresponds to a send gesture command and a state transition diagram 1104 of a DFA corresponds to a receive gesture command. The state transition diagram 1102 represents the DFA corresponding to a send gesture and defines a start state q1. The valid stroke ‘g’ can allow the state transition to enter into a state q4. Another stroke such as a, b, c, d, e, f, h, and u can allow the state transition to enter into the unacceptable state q9. If the second stroke is ‘g’ the state transition can enter into the state q6, else for all other strokes the state transition can enter into the unacceptable or the blocked state q9. At the state q6 with third stroke as ‘a’, the state transition can enter into the state q7 else into the blocked state q9. At q7 with fourth stroke ‘a’, the state transition enters into the state q8 else for another stroke the state transition enters into the blocked state q9. At the state q8 with fifth stroke ‘c’, the state transition can enter into the state q5, else into the blocked state q9. At the state q5 with sixth stroke ‘c’, the state transition enters into the final state q3, and for another stroke the state transition enters into the blocked state q9. Once a blocked state is reached, any further stroke performed is an invalid stroke and the state transition is held in the blocked state q9.

The state diagram 1104 represents the DFA corresponding to the receive gesture defines the start state q3. The valid stroke ‘f’ results in the state transition entering into the state q0. Another stroke comprising (a, b, c, d, e, f, h, and u) results in the state transition entering into the unacceptable state q9. At the state q0 with stroke ‘f’, the state transition enters into the state q6 else for another stroke the state transition can enter into the blocked state q9. Once the blocked state q9 is reached a further stroke performed by the user is an invalid stroke and the state transition is held in the blocked state.

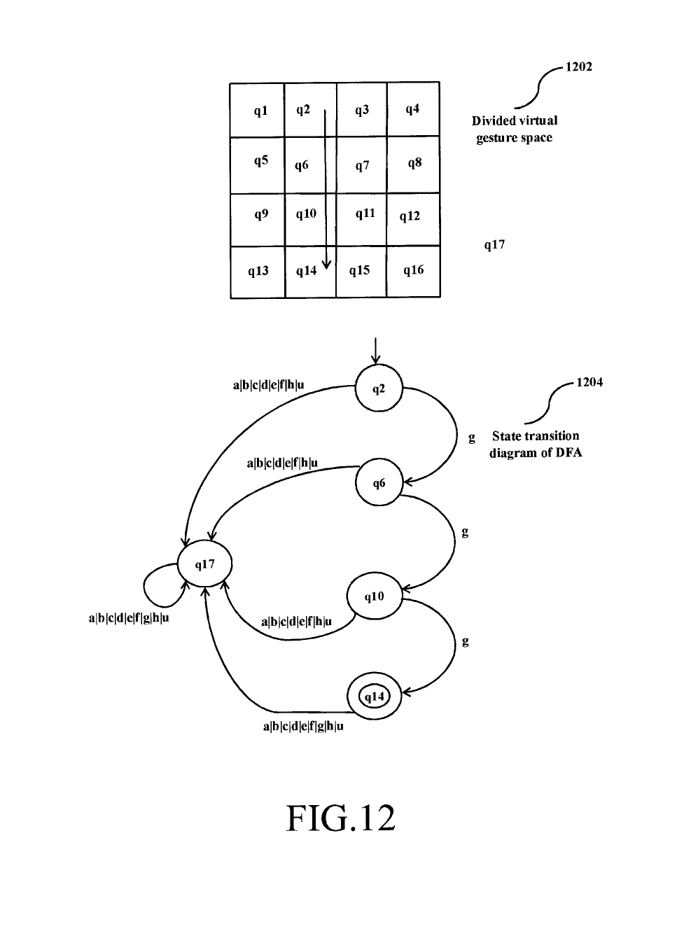

FIG. 12 illustrates a generalized framework of gesture recognition used in Augmented Reality (AR) application and shows a divided virtual space 1202 of a device with sixteen non-overlapping blocks assigned to the states q1 to q16 and q17 (representing a blocked state). The generalized framework for gesture recognition is used in AR applications where it is often required to fetch specific data related to an object displayed on the device screen. The divided virtual space 1202 depicts a gesture q2->q6->q10->q14, which can execute a data fetch operation. Further, state transition diagram 1204 of a DFA corresponds to the gesture depicted in divided virtual space 1202. The start state for the gesture is defined as q2. At the state q2 with stroke ‘g’, the state transition enters into the state q6 else the state transition can in to the blocked state q17. At the state q6 with stroke ‘g’, the state transition enters into the state q10 else for another stroke the state transition enters into the blocked state q17. At the state q10 with stroke ‘g’, the state transition enters into the state q14, which represents acceptable (final) state else the state transition can enter into the block state q17. Once the blocked state is reached any further stroke performed by the user is an invalid stroke and the state transition is held in the blocked state. Similarly, the generalized framework for the gesture recognition may be used in various electronic systems, for example, mobile phones, PDAs, or another system.

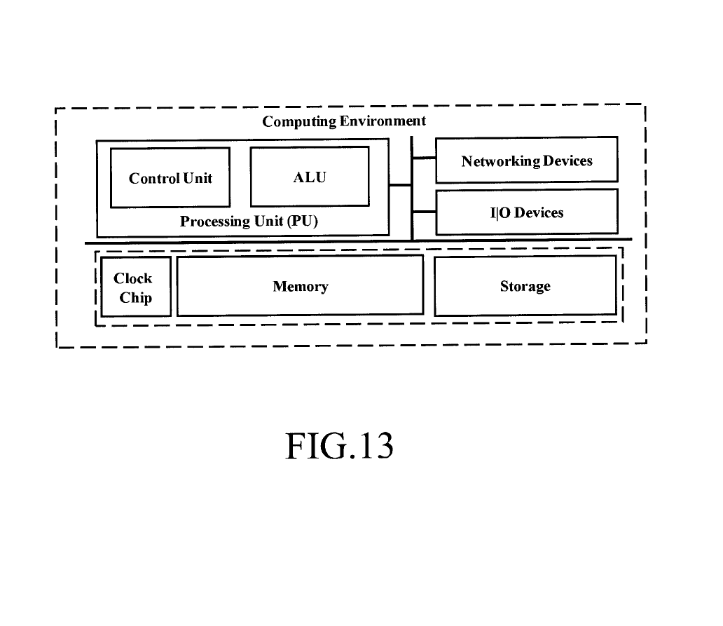

FIG. 13 illustrates a computing environment implementing the application, in accordance with various embodiments of the present invention. As depicted the computing environment comprises at least one processing unit that is equipped with a control unit and an Arithmetic Logic Unit (ALU), a memory, a storage unit, a clock chip, plurality of networking devices, and a plurality Input output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment is composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, the logical and the arithmetic operations involved in the execution of the instructions are computed with the help of the ALU. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit. The processing unit synchronizes the operations and executes the instructions based on the timing signals generated by the clock chip.

In case of any hardware implementations various networking devices or external I/O devices may be connected to the computing environment to support the implementation through the networking unit and the I/O device unit.

The apparatuses and methods disclosed herein may be implemented through at least one software program running on at least one hardware device and performing network management functions to control the elements. The elements shown in FIGS. 1 through 13 include blocks which may be at least one of a hardware device, or a combination of hardware device and software module.

The above embodiments described in this disclosure can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed disclosure. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein is practiced with modification within the spirit and scope of the embodiments as described herein.

We claim:

1. A method for gesture recognition, the method comprising:
receiving input data from a sensor comprising data representing at least one gesture motion;
dividing a space associated with gesture detection by said sensor into a plurality of blocks;
assigning said plurality of blocks to corresponding states;
generating a gesture specific sequence of states in response to the received input data; and
recognizing a gesture in response to the generated gesture specific sequence.

2. The method of claim 1, wherein the method for gesture recognition uses Deterministic Finite Automata (DFA) in generating a gesture specific DFA, said at least one gesture motion based on at least one stroke, wherein said at least one stroke comprises at least one of valid stroke and invalid stroke.

3. The method of claim 2, wherein said at least one stroke further comprises a pointer indicating at least one orientation of said at least one gesture motion.

4. The method of claim 1, wherein said method constructs said gesture specific sequence of states in response to at least one of alphabet, state transition rule, initial state, set of final states, and set of finite states, wherein said alphabet comprises said at least one of valid stroke and invalid stroke.

5. The method of claim 4, wherein recognizing a gesture in response to the generated gesture specific sequence, further comprises:
receiving said gesture input;
generating at least one string of symbols of said gesture in response to said alphabet;
determining whether said at least one string of symbols matches the generated gesture specific sequence; and
recognizing said gesture in response to determining that said at least one string of symbols matches the generated gesture specific sequence.

6. The method of claim 1, wherein the space associated with gesture detection by said sensor comprises at least one of a real gesture space of said sensor and a virtual gesture space and a two dimensional space or a three dimensional space.

7. The method of claim 1, wherein said method further comprises recognizing a multi-stroke gesture by using a sequential representation of at least one stroke.

8. The method of claim 7, wherein said at least one stroke is spanned over at least one block.

9. The method of claim 1, wherein said method further comprises transferring at least one object between a first device and a second device in response with the at least one gesture motion.

10. The method of claim 9, wherein said object is transferred using at least one of send command and receive command executed by said at least one of first device and second device in response to the at least one gesture motion.

11. A system for gesture recognition, the system comprising:
an interface module configured to receive input data from a sensor comprising data representing at least one gesture motion;
a module configured to:
divide a space associated with gesture detection by said sensor into a plurality of blocks,
assign said plurality of blocks to corresponding states, and
generate a gesture specific sequence of states in response to the received input data; and
a gesture recognition module configured to recognize a gesture in response to the generated gesture specific sequence.

12. The system of claim 11, wherein the system for gesture recognition uses Deterministic Finite Automata (DFA) in generating a gesture specific DFA and said at least one gesture motion is provided based on at least one stroke, wherein said at least one stroke comprises at least one of valid stroke and invalid stroke.

13. The system of claim 12, wherein said at least one stroke further comprises a pointer indicating at least one orientation of said at least one gesture motion.

14. The system of claim 11, wherein said module is configured to construct said gesture specific sequence in response to at least one of alphabet, state transition rule, initial state, set of final states, and set of finite states, wherein said alphabet comprises at least one of valid stroke and invalid stroke.

15. The system of claim 11, wherein said gesture recognition module is further configured to:
receive said gesture input using said interface module;
construct at least one string of symbols of said gesture in response to said alphabet using said module;
determine whether said at least one string of symbols matches the generated gesture specific sequence; and
recognize said gesture in response to determining that said at least one string of symbols matches the generated gesture specific sequence.

16. The system of claim 11, wherein the system further comprises:
a storage module configured to store the generated gesture specific sequence; and
a display module configured to display the space associated with gesture detection by said sensor, wherein said space comprises at least one of a real gesture space of said sensor and a virtual gesture space and a two dimensional space or a three dimensional space.

17. The system of claim 11, wherein said module is further configured to recognize a multi-stroke gesture by using a sequential representation of at least one stroke, wherein said at least one stroke is spanned over at least one block.

18. The system of claim 11, wherein said interface module is configured to transfer at least one object between a first device and a second device in response to the at least one gesture motion.

19. The system of claim 18, wherein said object is transferred using at least one of send and receive commands executed by said at least one of first device and second device in response to the at least one gesture motion.
